(19) United States
(12) Patent Application Publication
(10) Pub. No.: US 2013/0096796 A1
(43) Pub. Date: Apr. 18, 2013

(54) ELECTRONIC PARKING BRAKE SYSTEM AND CONTROL METHOD THEREOF

(71) Applicant: MANDO CORPORATION, Pyeongtaek-si (KR)

(72) Inventor: Chan Hee LEE, Gyeongbuk (KR)

(73) Assignee: MANDO CORPORATION, Pyeongtaek-si (KR)

(21) Appl. No.: 13/652,140

(22) Filed: Oct. 15, 2012

(30) Foreign Application Priority Data
Oct. 14, 2011 (KR) 10-2011-0105057

(51) Int. Cl. B60T 13/74; B60T 7/12

(52) U.S. Cl. 701/70

(57) ABSTRACT

Disclosed are an electronic parking brake system and a control method thereof. An aspect is to protect an electronic parking brake system by judging whether it enters a control mode based on results of monitoring a peripheral temperature of the electronic parking brake system and a motor temperature after operation. The electronic parking brake system includes a locking/unlocking switch to lock or unlock an electronic parking brake, a motor to drive the electronic parking brake, a temperature sensor to measure a peripheral temperature around the motor, and a controller that limits a locking function of the electronic parking brake when the repetition number of locking/unlocking operations of the electronic parking brake is zero for a predetermined short time under assumption that the temperature sensor breaks down, so as to prevent occurrence of breakdown due to overload and overheating of the motor.

### CROSS-REFERENCE TO RELATED APPLICATION

This application claims the benefit of Korean Patent Application No. 2011-0105057, filed on Oct. 14, 2011 in the Korean Intellectual Property Office, the disclosure of which is incorporated herein by reference.

### BACKGROUND

1. Field

Embodiments of the present invention relate to an electronic parking brake system of a vehicle.

2. Description of the Related Art

A vehicle is equipped with a brake system for deceleration or stopping. Such a brake system may include a traveling brake that decelerates or stops a vehicle during traveling, and a parking brake that is used when stopping or parking a vehicle.

The parking brake is formed of a brake pedal that a driver can operate, and brake pads that brake discs (or drums) of front and rear wheels according to operation of the brake pedal. The parking brake functions to prevent movement of a vehicle that is stationary. When the driver pulls a lever of the parking brake, a lining toward a rear wheel is brought into close contact with the drum by a cable connected to the lever, maintaining wheel braking. The driver may often operate the parking brake to prevent forward or rearward slip of a vehicle when parking the vehicle on a slope, for example.

Although the parking brake typically has a mechanical configuration in which the parking brake is actuated or released as the lever pulls or loosens the cable, in recent years, an Electronic Parking Brake (EPB) that enables simple and convenient operation of a parking brake using a switch is also used as occasion demands.

The EPB system is switchable to a manual mode as the driver simply operates a switch. In addition, the EPB system is adapted to automatically actuate or release the parking brake as necessary in association with a variety of controllers, such as an Engine Control Unit (ECU), Transmission Control Unit (TCU), Electronic Stability Program (ESP), etc.

In a manual mode, the EPB system actuates and releases the parking brake via a locking/unlocking switch. In an automatic mode, if the ignition is suddenly turned off or during stop of a vehicle, the EPB system is automatically converted into a parked state, and is released when an accelerator pedal is pushed.

The EPB system functions to automatically compensate shortage of brake force due to cable sagging and pad wear via monitoring of brake force. Additionally, releasing the EPB system via only locking/unlocking switch operation in an ignition-off state may be impossible, and forcibly releasing the EPB system using external tools may also be necessary when battery discharge occurs after long-term parking.

However, in the EPB system, if a motor is continuously operated despite overload or high-temperature heat generation of the motor, for example, burnout of the motor may occur, causing breakdown of the brake system.

### SUMMARY

Therefore, it is an aspect of the present invention to protect an electronic parking brake system by judging whether it enters a control mode based on results of monitoring a peripheral temperature of the electronic parking brake system and a motor temperature after operation.

Additional aspects of the invention will be set forth in part in the description which follows and, in part, will be obvious from the description, or may be learned by practice of the invention.

In accordance with one aspect of the present invention, an electronic parking brake system includes a locking/unlocking switch to lock or unlock an electronic parking brake, a motor to drive the electronic parking brake, a temperature sensor to measure a peripheral temperature around the motor, and a controller that limits a locking function of the electronic parking brake when the repetition number of locking/unlocking operations of the electronic parking brake is zero for a predetermined short time under assumption that the temperature sensor breaks down, so as to prevent occurrence of breakdown due to overload and overheating of the motor.

The controller may reduce a count value when the temperature sensor is not normally operated and the locking/unlocking switch is turned on.

The controller may increase the count value when the temperature sensor is not normally operated and the locking/unlocking switch does not generate a locking/unlocking input.

The controller may limit the locking function of the electronic parking brake system when the temperature sensor is not normally operated and a temperature measured by the temperature sensor is deviated from a preset normal temperature range, so as to prevent occurrence of breakdown due to overload and overheating of the motor.

In accordance with another aspect of the present invention, a control method of an electronic parking brake system that includes a locking/unlocking switch to lock or unlock an electronic parking brake, a motor to drive the electronic parking brake, and a temperature sensor to measure a peripheral temperature around the motor, includes counting the repetition number of locking/unlocking operations of the electronic parking brake for a preset short time when the temperature sensor breaks down, and limiting a locking function of the electronic parking brake when the repetition number is zero, so as to prevent occurrence of breakdown due to overload and overheating of the motor.

The method may further include reducing a count value when the temperature sensor is not normally operated and the locking/unlocking switch is turned on.

The method may further include increasing the count value when the temperature sensor is not normally operated and the locking/unlocking switch does not generate a locking/unlocking input.

The method may further include limiting the locking function of the electronic parking brake system when the temperature sensor is not normally operated and a temperature measured by the temperature sensor is deviated from a preset normal temperature range, so as to prevent occurrence of breakdown due to overload and overheating of the motor.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view illustrating a configuration of an electronic parking brake system according to an embodiment of the present invention;

FIG. 2 is a view illustrating a control system of the electronic parking brake system illustrated in FIG. 1; and

FIG. 3 is a view illustrating a control method of the electronic parking brake system according to an embodiment of the present invention.

### DETAILED DESCRIPTION

Reference will now be made in detail to the embodiment of the present invention, examples of which are illustrated in the accompanying drawings, wherein like reference numerals refer to like elements throughout.

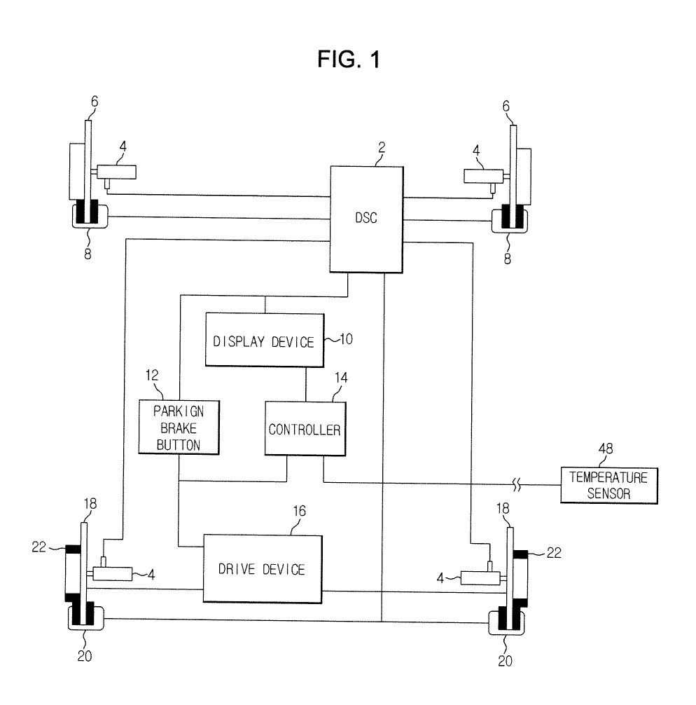

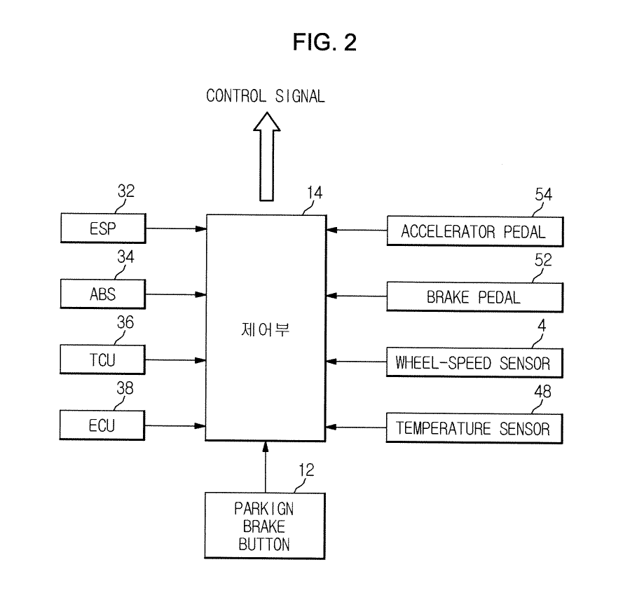

FIG. 1 is a view illustrating a configuration of an electronic parking brake system according to an embodiment of the present invention, and FIG. 2 is a view illustrating a control system of the electronic parking brake system illustrated in FIG. 1. As illustrated in FIGS. 1 and 2, wheel-speed sensors 4 are respectively provided on front-wheel discs 6 and rear-wheel discs 18 of a vehicle. Additionally, front-wheel brakes 8 or rear-wheel brakes 20 as traveling brakes are respectively provided on the front-wheel discs 6 or the rear-wheel discs 18. These traveling brakes are connected to a brake pedal 52 that a driver can operate.

The rear-wheel discs 18 are provided with parking brakes 22 that generate brake force to keep a vehicle stationary. The parking brakes 22 are connected to a drive device 16 that drive the parking brakes 22.

To actuate the parking brakes 22, a locking/unlocking switch 12 to be operated by the driver are provided within the vehicle. The parking brakes 22, the drive device 16, and the locking/unlocking switch 12 are electrically connected to a Dynamic Stability Control (DSC) module 2 or an Electronic Stability Program (ESP) module 32.

A temperature sensor 48 to sense a peripheral temperature around a motor for brake driving is provided. The DSC module 2 or the ESP module 32 and the temperature sensor 48 are electrically connected to a controller 14 so as to perform communication with the controller 14. A display device 10 may further be provided within the vehicle to display an operating state of the locking/unlocking switch 12 and an operating state controlled by the controller 14.

The controller 14 may be connected to a variety of vehicle control systems, such as the EPS module 32, an Anti-lock Brake System (ABS) module 34, a Traction Control System (TCS) module 36, and an Engine Control Unit (ECU) 38, for example. Operating signals of the brake pedal 52, accelerator pedal 54 and wheel-speed sensors 4 may be input to the controller 14. The controller 14 may actuate or release the traveling brakes 8 and 20 or the parking brakes 22 in association with the ESP module 32, ABS module 34, TCS module 36, Traction Control Unit (TCU) module 36, ECU module 38, and wheel speed sensors 4, for example.

Additionally, the vehicle is provided with an automatic switch 40, a semi-automatic switch 42, and a manual switch 44, which are connected to the controller 14. The driver may actuate or release the traveling brakes 8 and 20 and the parking brakes 22 via selection of these switches 40, 42 and 44.

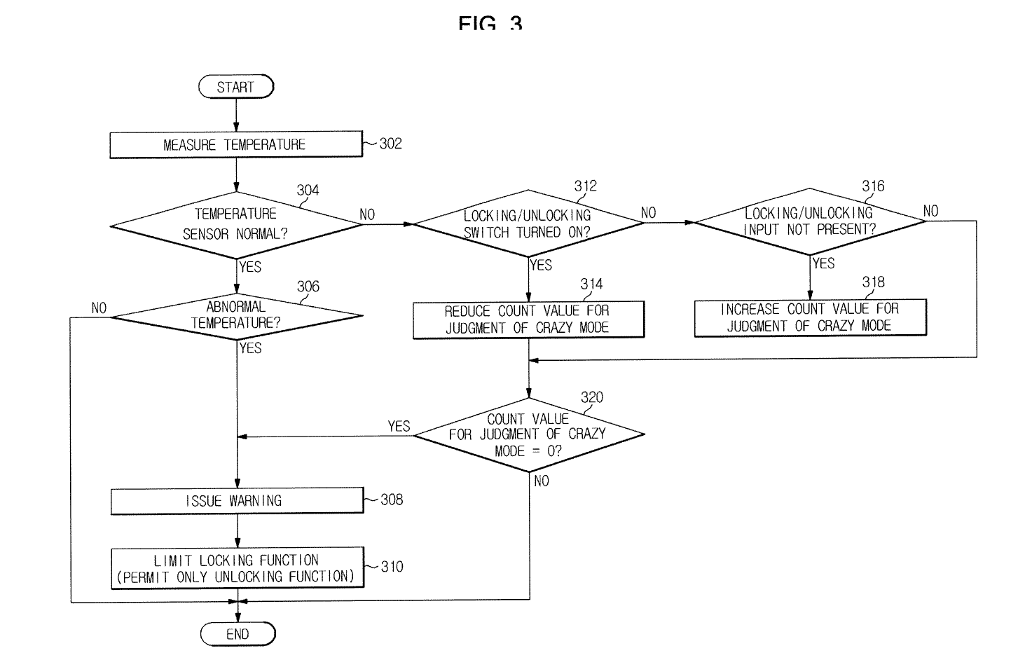

FIG. 3 is a view illustrating a control method of the electronic parking brake system according to an embodiment of the present invention. As illustrated in FIG. 3, the temperature sensor 48 measures a peripheral temperature around the motor (302). If the temperature sensor 48 is normally operated during temperature measurement (Yes in Operation 304), it is confirmed whether the measured temperature is within a normal temperature range (306). If the measured temperature is within an abnormal temperature range (Yes in Operation 306), a warning is issued (308), and a locking function of the electronic parking brake system is limited to prevent breakdown, such as burnout of the motor due to immoderate use of the motor (310). In this case, a function of releasing the locked brake is permitted.

Returning to Operation 304, if the temperature sensor 48 is not normally operated due to breakdown (No in Operation 304), it is confirmed whether the locking/unlocking switch 12 is turned on (312). If the locking/unlocking switch 12 is turned on (Yes in Operation 312), a count value for judgment of a so-called crazy mode is reduced (314). Here, the crazy mode is a mode in which locking and unlocking operations of the parking brakes are repeated for a predetermined short time (e.g., 5 seconds).

Returning to Operation 312, if the locking/unlocking switch 12 is turned off (No in Operation 312), it is confirmed whether a locking/unlocking input is generated (316). If the locking/unlocking input is not generated (Yes in Operation 316), the count value for judgment of the crazy mode is increased (318).

If the count value for judgment of the crazy mode reaches zero (Yes in Operation 320) through reduction in the count value for judgment of the crazy mode in Operation 314 and increase in the count value for judgment of the crazy mode in Operation 318, the aforementioned Operations 308 and 310 are performed to issue a warning and to limit the locking function of the electronic parking brake system, which prevents breakdown, such as burnout of the motor due to excessive operation of the motor. In this case, a function of releasing the locked brake is permitted.

That is, protection of the electronic parking brake system may be accomplished by performing a series of actions (issuing a warning and limiting a locking function) via the crazy mode when breakdown of the temperature sensor 12 occurs.

As is apparent from the above description, it may be possible to prevent breakdown, such as burnout of a motor due to overload or overheating by actuating the motor only within a workable temperature range of a brake based on monitored results with respect to a peripheral temperature around an electronic parking brake system and a motor operating temperature.

Further, when a temperature sensor breaks down, it may be possible to protect the electronic parking brake system via utilization of a so-called crazy mode.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electronic parking brake system comprising:
a locking/unlocking switch to lock or unlock an electronic parking brake;
a motor to drive the electronic parking brake;
a temperature sensor to measure a peripheral temperature around the motor; and
a controller that limits a locking function of the electronic parking brake when the repetition number of locking/unlocking operations of the electronic parking brake is zero for a predetermined short time under assumption that the temperature sensor breaks down, so as to prevent occurrence of breakdown due to overload and overheating of the motor.

2. The system according to claim 1, wherein the controller reduces a count value when the temperature sensor is not normally operated and the locking/unlocking switch is turned on.

3. The system according to claim 2, wherein the controller increases the count value when the temperature sensor is not normally operated and the locking/unlocking switch does not generate a locking/unlocking input.

4. The system according to claim 1, wherein the controller limits the locking function of the electronic parking brake system when the temperature sensor is not normally operated and a temperature measured by the temperature sensor is deviated from a preset normal temperature range, so as to prevent occurrence of breakdown due to overload and overheating of the motor.

5. A control method of an electronic parking brake system comprising a locking/unlocking switch to lock or unlock an electronic parking brake, a motor to drive the electronic parking brake, and a temperature sensor to measure a peripheral temperature around the motor, the control method comprising:
counting the repetition number of locking/unlocking operations of the electronic parking brake for a preset short time when the temperature sensor breaks down; and
limiting a locking function of the electronic parking brake when the repetition number is zero, so as to prevent occurrence of breakdown due to overload and overheating of the motor.

6. The method according to claim 5, further comprising reducing a count value when the temperature sensor is not normally operated and the locking/unlocking switch is turned on.

7. The method according to claim 6, further comprising increasing the count value when the temperature sensor is not normally operated and the locking/unlocking switch does not generate a locking/unlocking input.

8. The method according to claim 5, further comprising limiting the locking function of the electronic parking brake system when the temperature sensor is not normally operated and a temperature measured by the temperature sensor is deviated from a preset normal temperature range, so as to prevent occurrence of breakdown due to overload and overheating of the motor.
